(19) United States
(12) Patent Application Publication
(10) Pub. No.: US 2007/0111659 A1
(43) Pub. Date: May 17, 2007

(54) Method of improving receive sensitivity of satellite digital multimedia broadcasting

(75) Inventor: Sang-kyu Park, Gyeonggi-do (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Pantech&Curitel Communications, Inc.

(21) Appl. No.: 11/546,699

(22) Filed: Oct. 11, 2006

(30) Foreign Application Priority Data
Oct. 11, 2005 (KR) 10-2005-0095391

(51) Int. Cl. H04H 1/00; H04B 7/185

(52) U.S. Cl. 455/3.02; 455/12.1

(57) ABSTRACT

A method of improving the receive sensitivity of satellite DMB (digital multimedia broadcasting) in a mobile communication terminal is disclosed, the method including: a) receiving the satellite DMB through a gap filler; b) checking the receive sensitivity of the satellite DMB; and c) performing a process of improving the receive sensitivity when the receive sensitivity is less than a predetermined threshold value. In addition, a method of improving receive sensitivity of satellite DMB is disclosed, the method including: a) receiving from a mobile communication terminal a control request message of transmission power of a gap filler repeating the satellite DMB; and b) controlling the transmission power of the gap filler based on the control request message to increase the receive sensitivity of the satellite DMB in the mobile communication terminal.

### BACKGROUND OF THE INVENTION

This application claims the priority of Korean Patent Application No. 2005-95391, filed on Oct. 11, 2005, in the Korean Intellectual Property Office, the disclosure of which is incorporated herein in its entirety by reference.

1. Field of the Invention

The present invention relates to satellite digital multimedia broadcasting (DMB) and, more particularly, to a technique of improving the receive sensitivity of satellite DMB in a mobile communication terminal.

2. Description of Related Art

Satellite DMB is a digital transmission system for sending data, radio, and TV to communication terminals via satellites. Satellite DMB uses Ku-band (12 GHz) and S-band (2.6 GHz). A time-division multiplexing (TDM) mode is employed in the satellite DMB using Ku-band, while a code-division multiplexing (CDM) mode is employed in the satellite DMB using S-band. The Ku-band is used in providing a satellite DMB service using a gap filler on the ground. The gap filler is a system for repeating a satellite signal to be transmitted to a mobile communication terminal located in a blanket area in which the satellite signal is difficult to be received. In order to transmit a high-quality signal to a mobile communication terminal, a satellite transmits a TDM signal only to a gap filler. The gap filler demodulates the TDM signal, modulates the demodulated TDM signal into a CDM signal, and outputs the CDM signal as an S-band signal having 2.6 GHz. The gap filler uses a CDM technique to allow a mobile communication terminal to receive a signal in a multiple fading environment such as an urban area.

However, even though the gap filler is provided on the ground, the mobile communication terminal may not receive a satellite DMB signal when it is located at an area in which the receive sensitivity of the satellite DMB is low.

### SUMMARY OF THE INVENTION

The present invention provides a method of improving the receive sensitivity of satellite DMB.

According to an aspect of the present invention, there is provided a method of improving receive sensitivity of satellite digital multimedia broadcasting (DMB) in a mobile communication terminal, the method including: a) receiving the satellite DMB through a gap filler; b) checking the receive sensitivity of the satellite DMB; and c) performing a process of improving the receive sensitivity when the receive sensitivity is less than a predetermined threshold value.

The operation c) may include: c1) acquiring ID of the gap filler when the receive sensitivity is less than the threshold value; and c2) transmitting a message including the ID to a DMB center to request the DMB center to increase transmission power of the gap filler having the ID.

The operation c) may include: c1) acquiring ID of the gap filler and information concerning a base station when the receive sensitivity is less than the threshold value; and c2) transmitting a message including the ID and the information concerning a base station to a DMB center to request the DMB center to control a beam pattern of the gap filler having the ID to be directed to a communication area of the base station based on the information concerning the base station.

The information concerning a base station may be information concerning a base station sector.

The operation c) may include: c1) acquiring ID of the gap filler and information concerning a position of a mobile communication terminal when the receive sensitivity is less than the threshold value; and c2) transmitting a message including the ID and the information concerning a position of a mobile communication terminal to a DMB center to request the DMB center to control a beam pattern of the gap filler having the ID to be directed to the mobile communication terminal based on the information concerning the position of the mobile communication terminal.

The information concerning a position of a mobile communication terminal may be acquired using a global positioning system (GPS) in the operation c1).

According to another aspect of the present invention, there is provided a method of improving receive sensitivity of satellite DMB, the method including: a) receiving from a mobile communication terminal a control request message of transmission power of a gap filler repeating the satellite DMB; and b) controlling the transmission power of the gap filler based on the control request message to increase the receive sensitivity of the satellite DMB in the mobile communication terminal.

The control request message may include ID of the gap filler.

The transmission power of the gap filler having the ID may be increased in the operation b).

The control request message may include ID of the gap filler and information concerning a base station.

The information concerning a base station may be information concerning a base station sector.

In the operation b), a beam pattern of the gap filler having the ID may be controlled to be directed to a communication area of the base station based on the information concerning the base station.

A beam pattern of the gap filler having the ID may be controlled to be directed to the base station sector based on the information concerning the base station sector.

The control request message may include ID of the gap filler and information concerning a position of a mobile communication terminal.

In the operation b), a beam pattern of the gap filler having the ID may be controlled to be directed to the mobile communication terminal based on the information concerning the position of the mobile communication terminal.

### BRIEF DESCRIPTION OF THE DRAWINGS

The above and other features and advantages of the present invention will become more apparent by describing in detail exemplary embodiments thereof with reference to the attached drawings in which:

FIG. 1 is a system for improving the receive sensitivity of satellite DMB according to an embodiment of the present invention;

FIG. 2 is a block diagram of a mobile communication terminal receiving satellite DMB;

FIG. 3 is a detailed block diagram of the mobile communication terminal shown in FIG. 2;

FIG. 4 is a flow chart of a method of improving the receive sensitivity of satellite DMB in a mobile communication terminal according to an embodiment of the present invention;

FIG. 5 is a detailed flow chart of operation S300 of FIG. 4 according to an embodiment of the present invention;

FIG. 6 is a detailed flow chart of operation S300 of FIG. 4 according to another embodiment of the present invention;

FIG. 7 is a detailed flow chart of operation S300 of FIG. 4 according to an embodiment of the present invention;

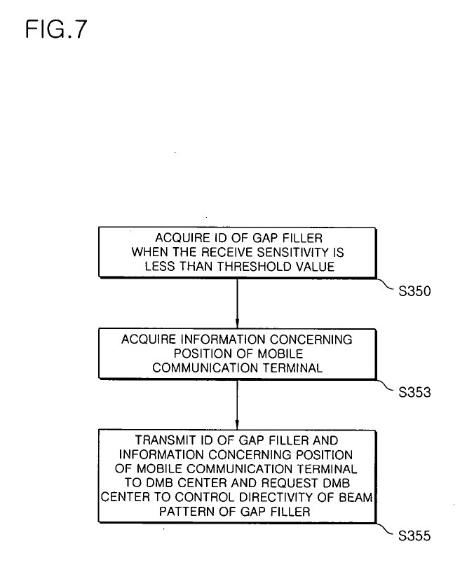

FIG. 8 is a flow chart of a method of improving the receive sensitivity of satellite DMB in a gap filler management server according to an embodiment of the present invention;

FIG. 9 is a view showing an increased transmission power of a gap filler;

FIG. 10 is a view showing directivity of a beam pattern of a gap filler; and

FIG. 11 is a configuration of DMB packet data.

### DETAILED DESCRIPTION OF THE INVENTION

Exemplary embodiments in accordance with the present invention will now be described in detail with reference to the accompanying drawings.

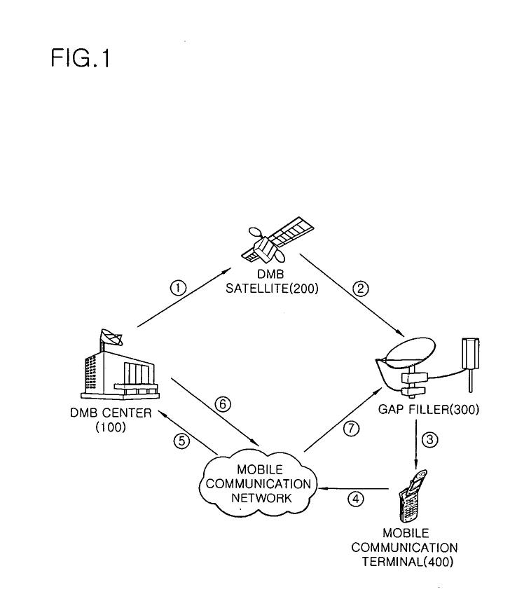

FIG. 1 is a system for improving the receive sensitivity of a satellite digital multimedia broadcasting (DMB) according to an embodiment of the present invention. A DMB center 100 transmits content information received from a program provider (PP) to a satellite. The DMB center 100 includes a gap filler management server (not shown) for managing a gap filler 300. The gap filler management server is responsible for monitoring the condition and trouble of the gap filler 300.

A DMB satellite 200 receives content information uplinked from the DMB center 100 and transmits the content information to DMB subscribers in Ku-band (12 GHz) and S-band (2.6 GHz). A satellite DMB service is provided in Ku-band through a gap filler 300 on the ground. The gap filler 300 converts a 12 GHz-band TDM signal received from the DMB satellite 200 into a 2.6 GHz-band CDM signal, amplifies the CDM signal, and transmits the amplified CDM signal to DMB subscribers over an antenna. The gap filler 300 is installed in a blanket area and covers about a radius of 500 m.

A mobile communication terminal 400 receives and plays the satellite DMB signal repeated through the gap filler 300. When the receive sensitivity of the satellite DMB signal is low, the mobile communication terminal 400 requests the DMB center 100 to improve the receive sensitivity over a mobile communication network. The gap filler management server provided in the DMB center 100 increases the transmission output of the gap filler 300 or controls the directivity of a beam pattern of the gap filler 300 to improve the receive sensitivity of the mobile communication terminal 400. Operation of the mobile communication terminal 400 and the gap filler management server will be described in detail.

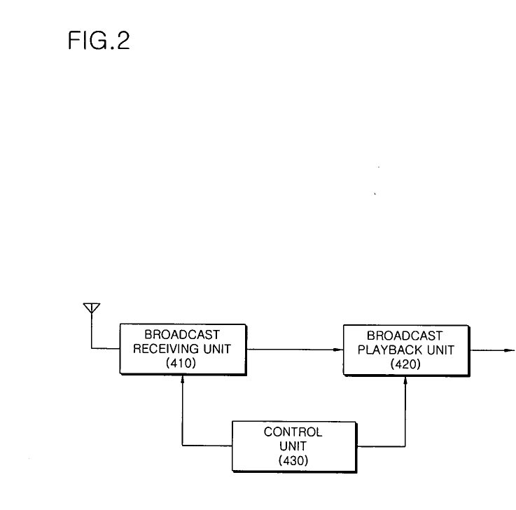

FIG. 2 is a block diagram of a mobile communication terminal that receives satellite DMB. The mobile communication terminal 400 receiving the satellite DMB includes a broadcast receiving unit 410 receiving broadcast streams, a broadcast playback unit 420 playing the broadcast streams received from the broadcast receiving unit 410, and a control unit 430 controlling the mobile communication terminal.

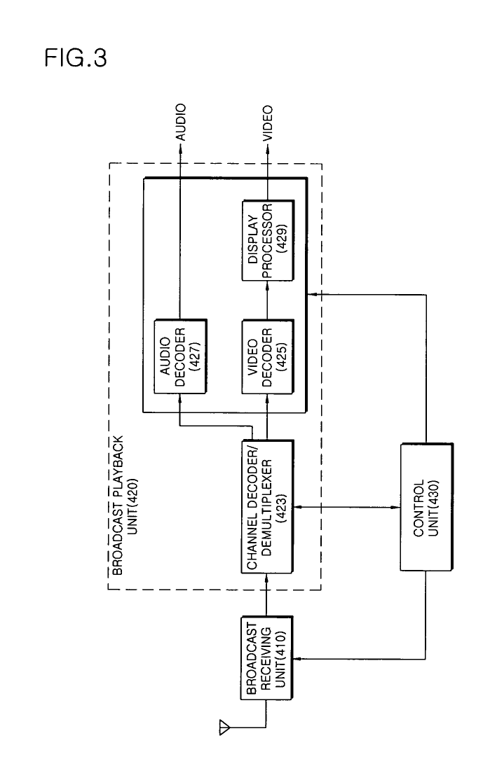

FIG. 3 is a detailed block diagram of the mobile communication terminal shown in FIG. 2. The control unit 430 executes a main program recorded on a memory unit to control the entire system. The mobile communication terminal 400 may be a mobile phone, and the control unit 430 may be a mobile station modem (MSM) manufactured by Qualcomm Inc. The broadcast receiving unit 410 includes a tuner and a demodulator. The broadcast receiving unit 410 tunes in to a desired broadcast channel under the control of the control unit 430, and acquires a transport stream (TS) through a demodulator.

A channel decoder/demultiplexer 423 checks whether or not there is an error on the transport stream, and demultiplexes it to a video bit stream, an audio bit stream, and other data. The video stream and audio stream demultiplexed by the demultiplexer 423 are input to a video decoder 425 and an audio decoder 427, respectively. The video and audio decoding process for the satellite DMB may be performed using MPEG techniques. The decoding process for the satellite DMB is well known in the art and a detailed description thereof will thus be omitted herein.

Each of the video decoder 425 and the audio decoder 427 performs a proper decoding process according to a coding method of the satellite DMB. The video decoder 425 decodes the video bit stream and outputs the decoded video bit stream to a display processor 429. The display processor 429 changes the decoded video bit stream to be suitable for a display mode. The audio decoder 427 decodes the audio bit stream and outputs the decoded audio bit stream as an audio signal. The image signal is preferably transmitted to a display unit (not shown) such as a liquid crystal display (LCD), and the audio signal is amplified and output through a speaker.

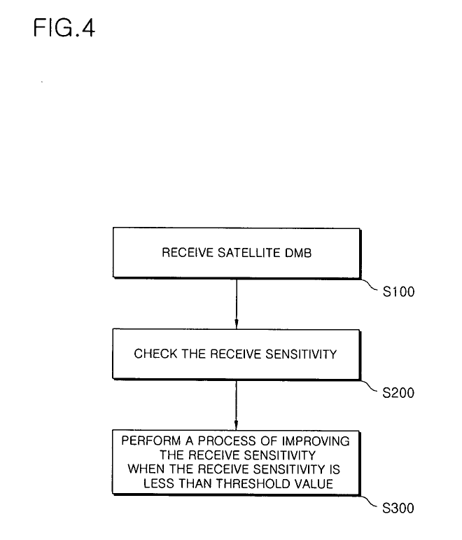

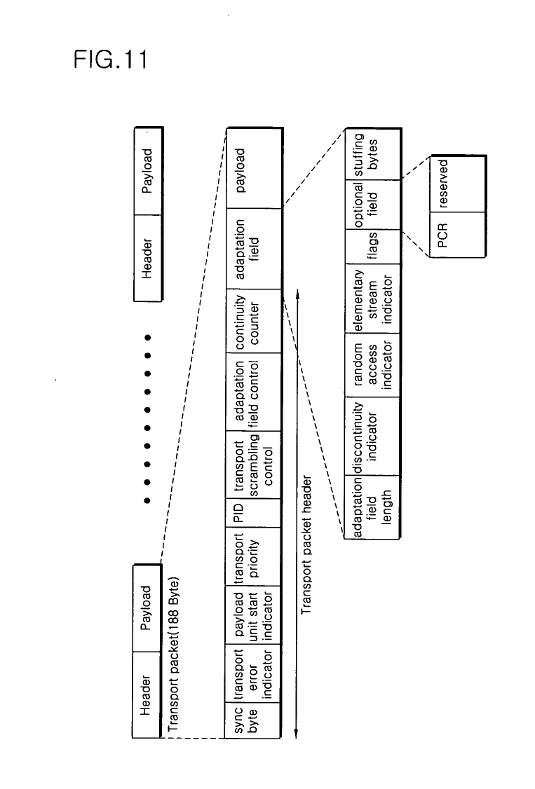

A method of improving the receive sensitivity of satellite DMB in the mobile communication terminal configured in this manner will be described in detail. FIG. 4 is a flow chart of a method of improving the receive sensitivity of satellite DMB in a mobile communication terminal according to an embodiment of the present invention. In a mode of receiving satellite DMB (operation S100), the control unit 430 checks the receive sensitivity of satellite DMB received through the gap filler 300 (operation S200). The receive sensitivity of satellite DMB is checked by checking whether or not there is an error on packet data of a broadcast stream received by the broadcast receiving unit 410, which will be described with reference to FIG. 11. FIG. 11 is a configuration of DMB packet data. A field ‘transport_error_indicator’ is set to a value of ‘1’ when there is an error in a packet decoded by the channel decoder/demultiplexer 423. When the value is detected by the channel decoder/demultiplexer 423, the packet is discarded. A field ‘continuity_counter’ increments or decrements between 0 and 15 one by one in a TS packet having the same PID (packet identifier), and is used to check whether or not the packet is lost upon processing the packet in the channel decoder/demultimplexer 423.

The control unit 430 may check the field ‘transport_error indicator’ or ‘continuity_counter’ to detect whether or not there is an error on packet data. In addition, the control unit 430 checks whether or not a proportion of packet data having an error in the broadcast stream is greater than a predetermined proportion. In one embodiment, when the proportion of packet data having an error is less than the predetermined proportion, the broadcast stream is interrupted so frequently that viewers cannot watch the broadcast. For example, when more than 8,000 of 10,000 packet data have an error, the proportion of packet data having an error is determined to be greater than the predetermined proportion. When the proportion of packet data having an error is greater than the predetermined value, i.e., when the receive sensitivity of satellite DMB is less than a threshold value, the control unit 430 performs a process of improving the receive sensitivity (operation S300).

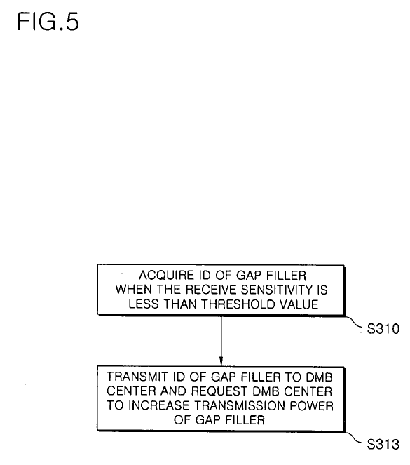

Embodiments of operation S300 will be described in detail. FIG. 5 is a flow chart of an embodiment of operation S300 of FIG. 4. The control unit 430 acquires ID of the gap filler 300 when the receive sensitivity is less than a threshold value in operation S200 (operation S310). In more detail, the control unit 430 acquires the ID of the gap filler 300 among data demultiplexed by the demultiplexer 423. The control unit 430 transmits the ID of the gap filler 300 to the gap filler management server of the DMB center 100 over the mobile communication network and requests the gap filler management server to increase the transmission power of the gap filler 300 (operation S313). The ID of the gap filler 300 may be transmitted through an SMS (short message service) message. The gap filler management server of the DMB center 100 increases the transmission power of the gap filler 300 to improve the receive sensitivity of satellite DMB in the mobile communication terminal 400.

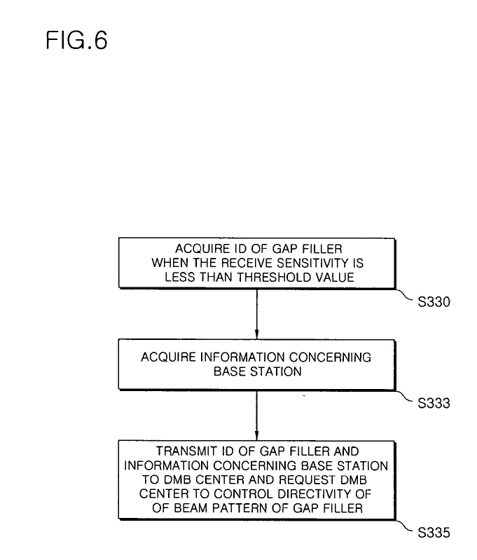

FIG. 6 is a flow chart of another embodiment of operation S300 of FIG. 4. When the receive sensitivity is less than the threshold value in operation S200, the control unit 430 acquires ID of the gap filler 300 among data demultiplexed by the demultiplexer 423 (operation S330), and acquires information concerning a base station (operation S333) In a CDMA system, the information concerning a base station is acquired over a paging channel at regular intervals according to a slot period. The base station covers a cell entirely or based on a plurality of sectors such as alpha, beta, and gamma. When the base station covers a cell based on a plurality of sectors, the information concerning the base station may be information concerning a base station sector.

The control unit 430 transmits the ID of the gap filler 300 and the information concerning a base station to the gap filler management server of the DMB center 100 over a mobile communication network and requests the gap filler management server to control a beam pattern of the gap filler 300 to be directed to a communication area of the base station according to the information concerning the base station (operation S335). The ID of the gap filler 300 and the information concerning the base station may be transmitted through an SMS message. The gap filler management server of the DMB center 100 controls the directivity of the beam pattern of the gap filler 300 to improve the receive sensitivity of satellite DMB in the mobile communication terminal 400.

FIG. 6 is a flow chart of another embodiment of operation S300 of FIG. 4. When the receive sensitivity is less than the threshold value in operation S200, the control unit 430 acquires ID of the gap filler 300 among data demultiplexed by the demultiplexer 423 (operation S350), and acquires information concerning a position of a mobile communication terminal (operation S353). In one embodiment, when the mobile communication terminal 400 is equipped with a GPS module, the control unit 430 receives data from a GPS satellite through the GPS module and acquires information concerning a position of the mobile communication terminal from the data. A technique of acquiring information concerning a position of a mobile communication terminal through a GPS module incorporated in the mobile communication terminal is well known in the art and a detailed description thereof will thus be omitted herein.

The control unit 430 transmits the ID of the gap filler 300 and the position information to the gap filler management server of the DMB center 100 over the mobile communication network and requests the gap filler management server to control a beam pattern of the gap filler 300 to be directed to the mobile communication terminal 400 (operation S355). The ID of the gap filler 300 and the position information may be transmitted through an SMS message. The gap filler management server of the DMB center 100 controls the directivity of the beam pattern of the gap filler 300 to improve the receive sensitivity of satellite DMB in the mobile communication terminal 400.

Accordingly, when the receive sensitivity of satellite DMB is weak, the mobile communication terminal 400 can request the DMB center 100 to improve the receive sensitivity. A method of improving the receive sensitivity of satellite DMB in the gap filler management server of the DMB center 100 will be described in detail.

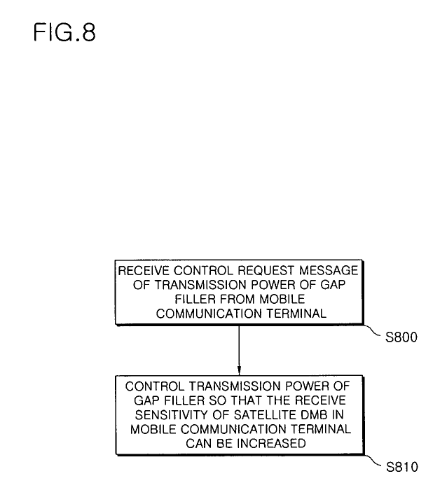

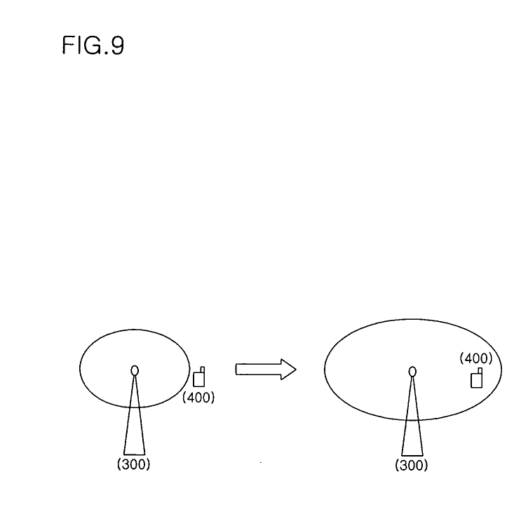

FIG. 8 is a flow chart of a method of improving the receive sensitivity of satellite DMB in a gap filler management server. The gap filler management server receives from a mobile communication terminal 400 a control request message of the transmission power of a gap filler 300 (operation S800). The transmission power control request message may include ID of the gap filler 300. In this case, the gap filler management server controls the transmission power of the gap filler 300 having the ID over the mobile communication network. It preferably controls the transmission power of the gap filler 300 to be increased (operation S810). Such a control can be performed by an SMS control message transmitted from the gap filler management server to the gap filler 300. It is well known in the art that the gap filler management server controls the gap filler through the mobile communication network. The gap filler 300 receives the control message from the gap filler management server and increases the transmission power of the gap filler 300 as shown in FIG. 9.

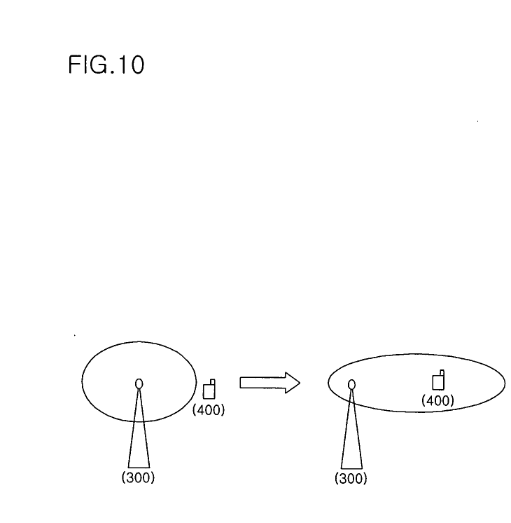

In another embodiment, the transmission power control request message includes ID of the gap filler 300 and information concerning a base station. The gap filler management server acquires a position of a gap filler 300 by referring to the ID of the gap filler 300 and acquires a communication area of the base station from the information concerning the base station. The gap filler management server preferably has a database required for acquiring the communication area of the base station from the information concerning the base station. Alternatively, the gap filler management server may acquire the information concerning the communication area of the base station from the information concerning the base station by connecting with mobile carriers. The gap filler management server controls the gap filler 300 such that a beam pattern of the gap filler 300 is directed to the communication area of the base station (operation S810). The information concerning the base station may be information concerning a base station sector. In this case, the gap filler management server controls the gap filler 300 such that the beam pattern of the gap filler 300 is directed to the communication area of the base station sector. The directivity of beam pattern may be controlled by an SMS control message transmitted from the gap filler management server to the gap filler 300 over the mobile communication network. The gap filler 300 receives a control message from the gap filler management server and radiates the beam pattern controlled as shown in FIG. 10.

The gap filler 300 may have an array antenna. The array antenna includes a plurality of antennas that are arranged according to a predetermined rule and radiates a sharp beam pattern in a predetermined direction by putting beam patterns of the antennas together. When the gap filler 300 has an array antenna, the gap filler management server transmits to the gap filler 300 a control message for varying the phase characteristic of each antenna so that the gap filler 300 can radiate the beam pattern to the communication area of the base station. The gap filler 300 receives the control message and varies the phase characteristic of each antenna of the array antenna to radiate the beam pattern as shown in FIG. 10.

In another embodiment, the transmission power control request message includes ID of the gap filler 300 and information concerning a position of a mobile communication terminal. In this case, the gap filler management server acquires a position of the gap filler 300 by referring to the ID of the gap filler 300 and controls the gap filler 300 such that the beam pattern of the gap filler 300 is directed to the mobile communication terminal based on the information concerning the position of the mobile communication terminal (operation S810). The directivity of beam pattern can be controlled by an SMS control message transmitted from the gap filler management server to the gap filler 300 over the mobile communication network. The gap filler 300 receives a control message from the gap filler management server and controls the directivity of the beam pattern of the gap filler 300. The directivity of the beam pattern radiated from the gap filler 300 is controlled as shown in FIG. 10.

As apparent from the above description, according to the present invention, it is possible to improve the receive sensitivity of satellite DMB in a mobile communication terminal since the transmission power of a gap filler can be controlled when the receive sensitivity is reduced.

Further, it is possible to determine a blanket area from information concerning a position of a mobile communication terminal, thus minimizing the blanket area upon designing a network in the future.

While the present invention has been described with reference to exemplary embodiments thereof, it will be understood by those skilled in the art that various changes in form and details may be made therein without departing from the scope of the present invention as defined by the following claims.

What is claimed is:

1. A method of improving receive sensitivity of satellite DMB (digital multimedia broadcasting) in a mobile communication terminal, the method comprising:
a) receiving the satellite DMB through a gap filler;
b) checking the receive sensitivity of the satellite DMB; and
c) performing a process of improving the receive sensitivity when the receive sensitivity is less than a predetermined threshold value.

2. The method of claim 1, wherein the operation c) comprises:
c1) acquiring ID of the gap filler when the receive sensitivity is less than the threshold value; and
c2) transmitting a message including the ID to a DMB center to request the DMB center to increase transmission power of the gap filler having the ID.

3. The method of claim 1, wherein the operation c) comprises:
c1) acquiring ID of the gap filler and information concerning a base station when the receive sensitivity is less than the threshold value; and
c2) transmitting a message including the ID and the information concerning a base station to a DMB center to request the DMB center to control a beam pattern of the gap filler having the ID to be directed to a communication area of the base station based on the information concerning the base station.

4. The method of claim 3, wherein the information concerning a base station is information concerning a base station sector.

5. The method of claim 1, wherein the operation c) comprises:
c1) acquiring ID of the gap filler and information concerning a position of a mobile communication terminal when the receive sensitivity is less than the threshold value; and
c2) transmitting a message including the ID and the information concerning a position of a mobile communication terminal to a DMB center to request the DMB center to control a beam pattern of the gap filler having the ID to be directed to the mobile communication terminal based on the information concerning the position of the mobile communication terminal.

6. The method of claim 5, wherein, in the operation c1), the information concerning a position of a mobile communication terminal is acquired using GPS (global positioning system).

7. A method of improving receive sensitivity of satellite DMB, the method comprising:
a) receiving from a mobile communication terminal a control request message of transmission power of a gap filler repeating the satellite DMB; and
b) controlling the transmission power of the gap filler based on the control request message to increase the receive sensitivity of the satellite DMB in the mobile communication terminal.

8. The method of claim 7, wherein the control request message includes ID of the gap filler.

9. The method of claim 8, wherein, in the operation b), the transmission power of the gap filler having the ID is increased.

10. The method of claim 7, wherein the control request message includes ID of the gap filler and information concerning a base station.

11. The method of claim 10, wherein the information concerning a base station is information concerning a base station sector.

12. The method of claim 10, wherein, in the operation b) , a beam pattern of the gap filler having the ID is controlled to be directed to a communication area of the base station based on the information concerning the base station.

13. The method of claim 11, wherein a beam pattern of the gap filler having the ID is controlled to be directed to the base station sector based on the information concerning the base station sector.

14. The method of claim 7, wherein the control request message includes ID of the gap filler and information concerning a position of a mobile communication terminal.

15. The method of claim 14, wherein, in the operation b) , a beam pattern of the gap filler having the ID is controlled to be directed to the mobile communication terminal based on the information concerning the position of the mobile communication terminal.
